(19) United States
(12) Patent Application Publication
(10) Pub. No.: US 2020/0009474 A1
(43) Pub. Date: Jan. 9, 2020

(54) SYSTEMS AND METHODS USEFUL FOR EFFICIENT FLUID RUN-OFF SEPARATION OF LIQUID AND SOLID CONTAMINANTS

(71) Applicant: ADVANCED DRAINAGE SYSTEMS, INC., HILLIARD, OH (US)

(72) Inventor: Thomas E. PANK, Walkersville, MD (US)

(21) Appl. No.: 16/028,343

(22) Filed: Jul. 5, 2018

(51) Int. Cl. B01D 17/02; E03F 5/16; B01D 21/24; B01D 21/00

(52) U.S. Cl. CPC B01D 17/0208; E03F 5/16; B01D 2221/12; B01D 21/0012; B01D 21/0003; B01D 21/2444

(57) ABSTRACT

A system useful for cleaning solid and liquid contaminants from fluid run-off under varying flow rate conditions has an inlet enclosure; a main separation enclosure comprising an intake, an outlet, and an interior wall; and a foil attached to the interior wall of the main separation enclosure, the foil configured to smooth laminar flow of fluid in the main separation enclosure.

### FIELD

The disclosure relates to systems, apparatus, and methods useful for fluid run-off separation. In particular, the disclosure relates to fluid run-off systems configured to minimize scour effect in fluid run-off flow in systems that process and clean run-off fluid such as rain water to efficiently and effectively remove both solid and liquid contaminants.

### BACKGROUND

Fluid run-off separation systems include systems designed to process rainwater or other fluid run-off and separate oil or other contaminants therefrom to mitigate environmental impact. Such systems are well-known and are typically located at roadways, parking lots, filling stations, and other similar locations prone to sediment, trash, and oil accumulation.

Among related art fluid run-off separation systems are those used for removing liquid such as oil from run-off water. Some related art liquid fluid separation systems accommodate variations in flow rate of run-off water caused by factors such as variations in rainfall over different periods of time. For example, in U.S. Pat. No. 5,746,911, titled Apparatus for Separating a Light From a Heavy Liquid, the entire disclosure of which is hereby incorporated by reference herein, Thomas E. Pank discloses a system wherein run-off water enters an inlet tank in which oil in the run-off floats on a surface thereof. When run-off enters the inlet tank at a low rate, the surface of the fluid, including oil and water, in the inlet tank flows into a main separation tank. The oil floats on the surface of the water in the main separation tank, and clean water below the oil-contaminated surface exits the main separation tank through an outlet for delivery to a city sewer or river, for example. The outlet is positioned below the oil-contaminated surface of the fluid in the main separation tank.

Pank's system is configured to accommodate variation in flow rate of rainwater run-off processed using the dual-container liquid fluid separation apparatus. When the rainwater enters the system at a low flow rate, the surface water or oil in the inlet tank drains to the main separation tank. When the rainwater enters the system at an intermediate flow rate, clean water is fed from the inlet tank directly to the outlet conduit, bypassing the main separation tank. When the rainwater enters the inlet tank at a very high rate, for example during heavy rainfall, and the run-off reaches a predetermined level in the inlet tank, the rainwater overflows directly into the outlet conduit.

Other related systems are configured primarily to separate solids from rainwater, such as by forming a vortex in a container and extracting water from a top of the fill. For example, in U.S. patent application Ser. No. 15/646,794, titled Liquid Quality System With Drag Inducing Portions, the entire disclosure of which is hereby incorporated by reference herein, Babcanec discloses a single-container liquid quality system designed to reduce particulates in liquid runoff such as stormwater runoff Such liquid quality systems may advantageously be configured to induce a vortex in the liquid in an enclosure, causing suspended particulates to settle on the outside of the vortex, thereby separating the liquid from the particulates. If the velocity of the vortex is too great, however, the liquid flow may be very turbulent. Moreover, if the velocity of liquid flow is too great in the vortex, the settled particulates may become re-suspended. This is referred to as the “scour effect.”

Babcanec discloses a system that addresses the combination of turbulence and resuspension that limits cleansing functionality. In particular, Babcanec recognized that by forcing smooth directional changes in the fluid flow path, and directing the flow away from the outlet, the overall length of the flow path may increase. Additionally, by subjecting the vortex to drag, the velocities within the vortex may decrease.

For example, Babcanec discloses using drag inducing portions in an enclosure to force smooth directional changes and guide a liquid flow away from a sump outlet aperture at top of the enclosure. This is accomplished by positioning the drag inducing portion to project inwardly towards a central axis of the main separation enclosure. The drag-inducing portion have several functions: creating drag to slow the liquid flow velocities in the vortex; extending fluid flow path by forcing a smooth directional change; and guiding liquid away from the sump outlet aperture. Babcanec discloses that the orientation and angle of the drag-inducing portion may be selected to enhance settling efficiency, and that the impact of the drag-inducing portion may increase as the flow rate increases.

### SUMMARY

A need has been recognized for minimizing scour effect in fluid run off systems configured for separating both liquid and solid contaminants from run-off fluid. Further, a need has been recognized for mitigating flow turbulence during periods of intermediate and high flow of run-off such as stormwater in fluid run off systems configured to remove liquid and solid contaminants from run-off.

Systems useful for separating liquid and solid contaminants from fluid run-off with minimized scour effect are provided. Systems include an inlet enclosure and a main separation enclosure. The main separation enclosure includes an intake, an outlet, and interior wall formed to contain and induce a vortex in fluid run-off. The fluid run-off contains particulate solid contaminants, and is received from the intake, cleaned in the main separation enclosure, and delivered through the outlet to exit the fluid main separation enclosure. The main separation enclosure includes a foil configured to disrupt the flow of the fluid in the fluid main separation container. The intake connects to the inlet enclosure for delivering fluid therefrom to the interior of the main separation enclosure. During periods of high and intermediate flow, resuspension of solid particulates can occur in the main separation enclosure, causing re-contamination of cleansed water flowing through the outlet. The flow disruption caused by the foils minimizes turbulence and resuspension of solids or scour effect.

In an embodiment, the foil is arranged at an angle of attack selected from a range of 45 degrees to 60 degrees to the fluid flow. In another embodiment, the foil is arranged at an angle of attack of 60 degrees to the fluid flow. In yet another embodiment, the foil is arranged at an angle of attack of 45 degrees or greater.

In an embodiment, the foil is connected to the interior wall of the enclosure. In an embodiment, the foil is connected to a foil support, the foil support connected to the interior wall. In another embodiment, the foil is configured to extend toward a center of an interior of the enclosure.

In an embodiment, the system includes one or more additional foils. For example, a second foil may be connected to the interior wall of the main separation enclosure. In an embodiment, the first foil is arranged at a first angle of attack to the fluid flow in the enclosure, and the second foil is arranged at a second angle of attack to the fluid flow in the enclosure. In another embodiment, the first angle of attack is equal to the second angle of attack. In another embodiment, the first angle of attack great than the second angle of attack. In an embodiment, the first foil is positioned at an angle of attack that opposite to an angle of attack of the second foil. In yet another embodiment, the first foil is arranged at a distance from a top or bottom of the main separation enclosure that is different than a distance of a second foil from a top or bottom of the main separation enclosure.

An embodiment of methods useful for separating solid and liquid contaminants from fluid run-off includes receiving fluid run-off from in an inlet enclosure, the inlet enclosure configured to receive and fluid run-off having solid and liquid contaminants; transferring the fluid run-off from the inlet enclosure to a separation unit connected to a main separation enclosure by inlet and outlet pipes; receiving the fluid run-off from the separation unit in the main separation enclosure wherein liquid contaminant separates from water in the fluid run-off and rises to a top of the fill; cleaning the fluid run-off in the main separation enclosure configured to accommodate separation of liquid contaminant such as oil from water in the run-off, and configured with foils arranged to minimize scour effect under intermediate and high flow rate conditions to separate solids from the water; receiving the cleaned water at the separation unit from a region beneath a surface of the fill in the main separation enclosure through an outlet pipe; and outputting fluid separated from contaminants from the fluid separator enclosure at a clean fluid outlet.

An embodiment of methods useful for forming a system for separating solid and liquid contaminants from fluid run-off under varying flow rate conditions includes providing liquid fluid separation system; attaching a foil to an inner wall of a main separation enclosure the fluid run-off separation system arranged according to Stoke's Law at an angle of attack selected from an angle of 45 degrees to 60 degrees to enhance solid separation; and attaching a second foil to the inner wall of the main separation enclosure arranged according to Stoke's Law at an angle of attack selected from an angle of 45 degrees to 60 degrees to enhance solid separation.

Additional features and technical effects of the present disclosure will become readily apparent to those skilled in the art from the following detailed description wherein embodiments of the present disclosure are described simply by way of illustration of the best mode contemplated to carry out the present disclosure. In addition to the embodiments disclosed herein, other and different embodiments are within the spirit and scope of the disclosure, and its several details are capable of modifications in various respects.

### BRIEF DESCRIPTION OF DRAWINGS

The disclosure is shown by way of example in the figures of the accompanying drawings, in which like reference numerals refer to like elements.

FIG. 1 shows a cross-sectional plan view of a fluid-run-off separation system in accordance with an embodiment;

FIG. 2 shows a cross-sectional side view along line A of FIG. 1 in accordance with an embodiment;

FIG. 3 shows a cross-sectional side view along line B of FIG. 1 in accordance with an embodiment;

FIG. 4 shows a perspective view of a configuration of foils arranged in a system according to an embodiment;

FIG. 5 shows a perspective view of a configuration of foils arranged in accordance with another embodiment;

FIG. 6 shows a method useful for solid and liquid fluid run-off separation in accordance with an embodiment;

FIG. 7 shows a method useful for providing a system for solid and liquid fluid run-off separation in accordance with an embodiment.

### DETAILED DESCRIPTION OF EMBODIMENTS

In the following description, for the purposes of explanation, numerous specific details are set forth in order to provide a thorough understanding of exemplary embodiments. It should be apparent, however, that exemplary embodiments may be practiced without these specific details or with an equivalent arrangement. In other instances, well-known structures and devices are shown in block diagram form in order to avoid unnecessarily obscuring exemplary embodiments. In addition, unless otherwise indicated, all numbers expressing quantities, ratios, and numerical properties of ingredients, reaction conditions, and so forth used in the specification and claims are to be understood as being modified in all instances by the term “about.”

Embodiments of systems useful for separating liquid and solid contaminants from fluid run-off with minimized scour effect are disclosed. Exemplary systems useful for separating liquid contaminants are constructed in accordance with those disclosed by Pank and provided by Baysaver Technologies. In particular, Pank's system discloses a system having an inlet tank and main separation tank of round cross-section and comprising drop manholes with upper ends closed by manhole covers. Rainwater run-off enters the inlet tank through and inlet pipe and fills the inlet tank until the water overflows and is skimmed. The skimmed overflow fills an overflow enclosure, passes through a conduit and fills the main separation tank. Oil in the runoff floats on a surface of the water in the inlet tank and the main separation tank. Clean water below the surface of the water in the main separation tank exits through an outlet positioned below a surface of the water and oil in the main separation tank. Thus, separation of oil from rainwater is achieved and runoff may be safely discharge into municipal sewer systems or nearby waterways.

Systems and methods of the disclosed embodiments advantageously enhance liquid separation systems such as those disclosed by Pank by additionally facilitating efficient solid separation performance. Systems of embodiments accommodate variable flow rates, including intermediate and high rates of flow associated with moderate to severe stormwater runoff, respectively. Systems and methods of embodiments include foils or structures configured to disrupt flow, primarily in the main separation tank or enclosure of a liquid separation system such as Pank's. Accordingly, a water run-off management system and methods are provided that clean water to separate both liquids such as oil and other pollutants, sediments, and debris particulates even under intermediate and high rates of flow in the main separation tank or enclosure.

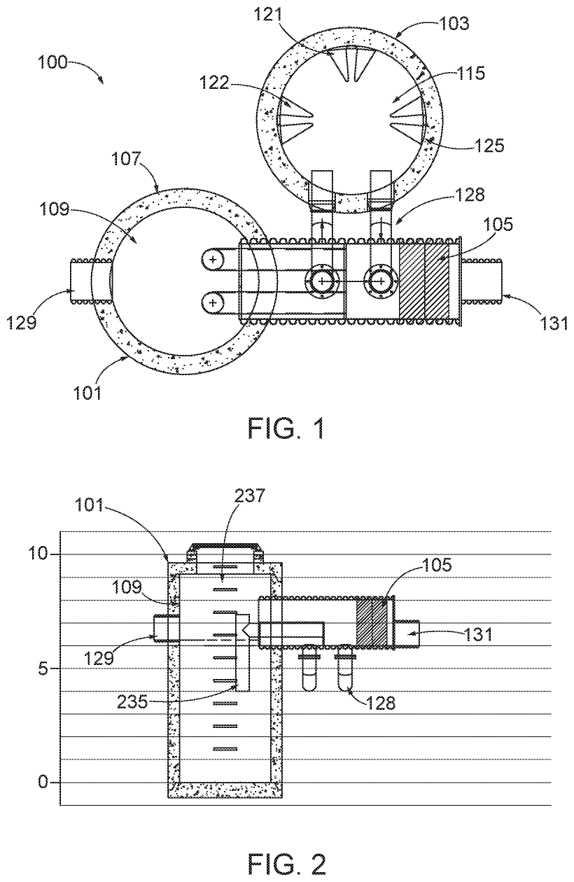

FIG. 1 shows a cross-sectional plan view a system useful for separating liquid and solid contaminants from fluid run-off with minimized scour effect in accordance with an embodiment. The system 100 includes an inlet enclosure 101 and a main separation enclosure 103 connected to the inlet enclosure 101 by a separator unit 105. The main separation enclosure has a wall 103, and the inlet enclosure has a wall 107. The interior 109 of the inlet enclosure 109 and the interior 115 of the main separation enclosure have round cross-sections. In other embodiments, the interiors may have alternate shapes or forms, particularly those configured to facilitate a vortex in fluid flowing in the enclosure whereby precipitation and resuspension of precipitate can occur. The may flow in accordance with the directional arrows shown in FIG. 1. The interior 115 of the main separation enclosure 103 has a first foil 121, a second foil 122, and a third foil 125.

The main separation enclosure 103 connects to the separator unit by two conduits or pipes 128. One pipe feeds fluid delivered from the inlet enclosure 101 to the main separation enclosure 103, and another pipe feeds clean fluid from the main separation enclosure 103 through the separator unit 105 to the system outlet 131 for delivery to municipal systems or nearby waterways. The pipe that feeds clean fluid from the main separation enclosure 103 is positioned below a surface of the fluid in the main separation enclosure 103.

FIG. 2 shows a cross-sectional side view along line A of FIG. 1 in accordance with an embodiment of a system useful for separating liquid and solid contaminants from fluid run-off with minimized scour effect. In particular, FIG. 2 shows a system 100 including an inlet enclosure 101 connected to a separator unit 105. The inlet enclosure 101 includes an L-shaped pipe 235 in an interior 109 of the inlet enclosure 101. The inlet enclosure 101 includes a manhole cover, and a ladder providing access to the interior 109 of the inlet enclosure 101 for maintenance personnel, for example.

The L-shaped pipe 235 feeds fluid from inlet enclosure 101 to the separator unit 105 for subsequent delivery of the fluid to the main separation enclosure (not shown) through an inlet pipe of pipes 128 disposed in the main separation enclosure. In an embodiment, the L-shaped pipe 235 may be one of two or more pipes connecting the interior 115 of the inlet enclosure 101 to the separation unit 105 or the interior of the main separation enclosure. In an embodiment, the pipe 235 may have an alternate shape suitable for efficiently feeding fluid such as water contaminated with oil to the main separation enclosure through the separator unit 105. Clean water flows from the main separation unit through an outlet pipe the pipes 128 to the separator unit 105 for exiting the system by outlet 131.

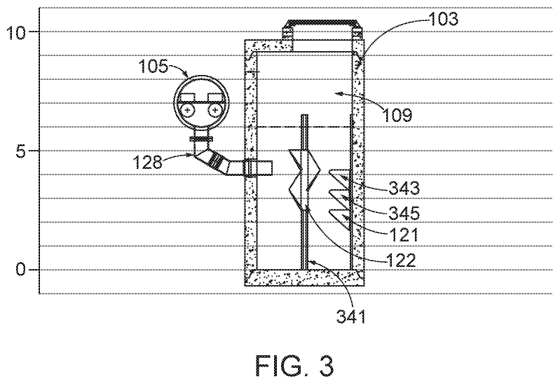

FIG. 3 shows a cross-sectional side view along line B of FIG. 1 in accordance with an exemplary embodiment of a system useful for separating liquid and solid contaminants from fluid run-off with minimized scour effect. In particular, FIG. 3 shows a system including a main separation enclosure 103 having a first foil 121 and a second foil 122 disposed in an interior 109 of the main separation enclosure 103. The foils 121 and 122 are attached to walls of the interior 109 of the main separation enclosure 103. For example, the foils may be attached to a support. FIG. 3 shows the foil 122 attached to the interior 109 of the separation enclosure 103 by a support 341.

The support 341 may be formed of any structure or material, now known or later developed, suitable for use in liquid and solid pollutant-contaminated fluid and for supporting foils under strain caused by flow of fluid at varying rates in the interior 109 of the main separation enclosure 103 as the foils induce drag in fluid flowing from the inlet enclosure (not shown) through the separator device 105 and an inlet of pipes 128, into the main separation enclosure 103, and back into the separator device 105 through an outlet of pipes 128 for discharge from the system outlet 131, as illustrated by directional arrows in FIGS. 1 and 2.

The foils may be formed of any suitable material suitable for use in liquid and solid fluid and maintaining rigid structure suitable for inducing drag in fluid under high rate of flow in the interior 109 of the main separation enclosure 103. FIG. 3 shows a third foil 343 disposed above the first foil 121. Multiple foils may be arranged on a single support, or may be attached to the wall in alignment, or offset. For example, the first foil 121 and the third foil 343 are vertically aligned with respect to a horizontal base of the main separation enclosure 103.

Foils of embodiments, as shown in FIGS. 1 and 2, for example, are configured to smooth laminar flow in the main separation tank. During periods of high water turbulence, foils configured as disclosed prevent resuspension of solids, or scour effect. Water turbulence affects water flow and influences settling characteristics of sediment in the flow. Generally, the greater the water turbulence and vortex, the greater the difficulty in removing sediment from fluid in a hydrodynamic separator, and the easier suspension and resuspension occurs. It has been found that under turbulent vortex conditions in the interior of a main separation enclosure, triangular shaped fins or flow disruptors force flow separation at a 60 degree angle of attack to effectively prevent resuspension of sediment. Thus, hydraulic conditions are improved by decreasing vortex turbulence in a main separation enclosure using one, or preferably multiple, foils or flow disruptors or foils affixed to the walls of the main separation enclosure. In embodiments, scour effect is minimized and separation efficiency optimized by including multiple foils angled at opposing directions at varying heights from the bottom of the interior of the main separation enclosure, and in both aligned and offset configurations.

The flow dispruptors or foils are arranged at optimal angles of attack to fluid flow to induce drag in fluid run-off flow to enhance separation, enhance hydraulic conditions, and decrease vortex turbulence in the separator enclosure. The angle of attack is an angle of a chord line of the foil and a vector substantially corresponding to relative motion of fluid flow.

Preferably, a foil is formed to have a shape that is substantially an isosceles right triangle. The edges of the foil may be rounded toward the center of a main separation enclosure. The foil may be configured whereby when liquid flow passes by the foil, the flow contacts a body of the foil and forms a boundary layer along a surface of the body. The boundary layer thickens by viscous diffusion, and convects downstream until the flow separates. Flow separation is subject to lift and drag forces from the angled attack of the foil.

In an embodiment, an angle of attack of a foil fitted to a main separation is a 60 degree angle. It has been found that this angle of attack advantageously enhances particle settling by increasing settling surface area and reducing settling distance. This angle also allows the settled solids to slide down the plate and to the bottom of the unit. A higher degree angle of attack may function, but with decreased the settling efficiency. An angle of less than 45 degrees may yield sediment accumulation on the surface of the one or more flow disruptors. Accordingly, an angle of attack of 45 degrees to 60 degrees is preferred. Further, an attack angle of 60 degrees is preferred.

In an embodiment, the foils are angled at opposing directions. In an embodiment, the foils are disposed at varying heights on the walls of the main separation enclosure, with respect to a bottom of the main separation enclosure. The foils are disposed on the walls of the main separation enclosure at different distances from a bottom or top of the main separation enclosure. As shown in FIG. 3, the foils are preferably disposed beneath a surface of a fluid fill, in clean fluid portion of a fluid-filled main separation enclosure.

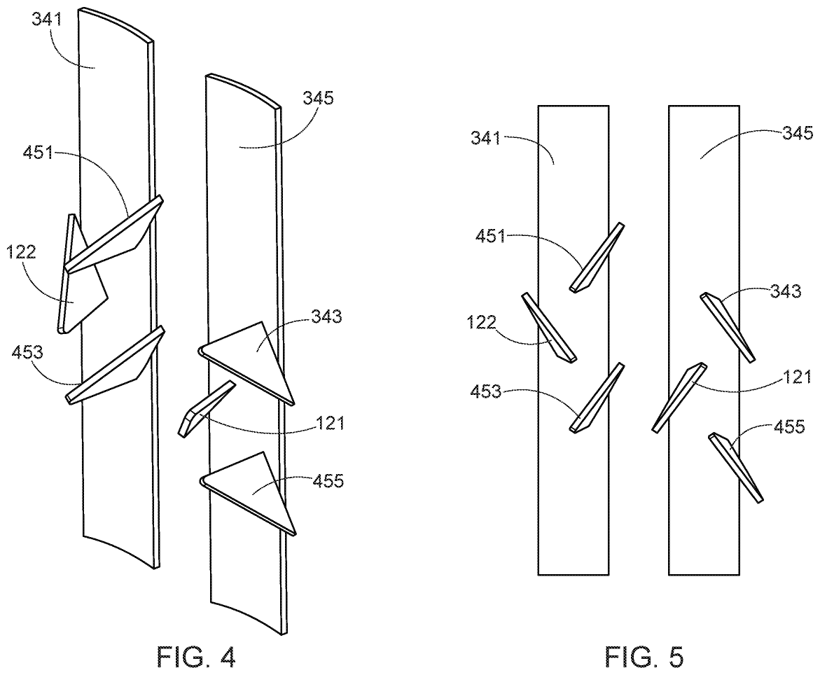

FIG. 4 shows a perspective view of foil configurations for use in systems for solid and liquid-contaminant fluid separation in accordance with an embodiment. In particular, FIG. 4 shows a first set of foils connected to a support 341, and a second set of foils connected to a second support 345. The supports may be attached to an interior of a main separation enclosure with the foils oriented to extend toward a center of the interior. The supports may be attached to a wall of an interior of a main separation enclosure as shown in FIG. 1 or FIG. 3. In an embodiment, the supports may be wall portions of the interior of the main separation enclosure.

FIG. 4 and FIG. 5 show a first set of foils 122, 451, and 453 arranged on a first support 341, and a second set of foils 121, 343, and 455. The foil 122 interposes the foil 451, disposed above the foil 122, and the foil 453, disposed below the foil 122, on the support 341. The foil 122 may be positioned at an angle that differs from an angle of the foil 451 or the foil 453 as shown. In an alternative embodiment not shown, the angle of the foil 122 may be the same as the angle of the foil 451 or the foil 453. In the embodiment shown in FIGS. 4 and 5, the upper foil 451 is disposed at an angle that is substantially the same as an angle of the foil 453, and the middle foil 122 has an angle that is supplement to the angle of the foil 451 or the foil 453. All foils are arranged to be disposed in a main separation enclosure below a fluid fill surface when the main separation enclosure contains fluid, or at or below an inlet to the main separation enclosure.

The foil 121 interposes the foil 343, disposed above the foil 121, and the foil 453, disposed below the foil 122, on the support 345. The foil 121 may be positioned at an angle that differs from an angle of the foil 451 or the foil 453. In an alternative embodiment not shown, the angle of the foil 122 may be the same as the angle of the foil 451 or the foil 453. In the embodiment shown in FIGS. 4 and 5, the upper foil 451 is disposed at an angle that is substantially the same as an angle of the foil 453, and the middle foil 122 has an angle that is supplement to the angle of the foil 451 or the foil 453. In the embodiment shown in FIGS. 4 and 5,

In an embodiment as shown in FIGS. 4 and 5, the support 341 includes foils arranged in a configuration that differs from a foil configuration of support 345. For example, a first foil 121 of the support 345 may be arranged as shown in FIGS. 4 and 5 to have an angle of attack that is different than an angle of attack of a second foil 122 of the support 341. The angles of attack are selected from angles within the above-mentioned range of 45 degrees to 60 degrees, and preferably 60 degrees. The angle of attack of foils 451 and 453 may be the same as, or as shown in FIGS. 4 and 5, may be supplement to the angle of foils 343 and 455.

The angular position of the foils is selected to according to Stoke's Law and “inclined plate” settling. Particulate settling may be facilitated by increasing the length of the flow path, reducing the vortex velocities, and reducing the settling distance by directing relatively smooth, laminar flow towards the bottom of an enclosure such as the main separation enclosure of a solid and liquid fluid separation system. A higher degree angle may decrease the settling efficiency, while an angle less than 45 degrees may lead to particulate accumulation on the surfaces of the foils.

The first foil 121 may be arranged at a height on the support 345 that is different than a height of the second foil 122 of the support 341, where the support 345 and the support 341 have substantially equal heights as shown. In an embodiment, the upper most or lower most foils may be disposed at same heights or at different heights as shown in FIGS. 4 and 5, with respect to a bottom or top of the support 341 or the support 345.

As shown in FIGS. 4 and 5, the foils may be arranged on same or different vertical axes. For example, a first foil 122 may be disposed along a vertical axis of the support 341 that is different than the vertical axis along which foils 451 and 453 are disposed, as shown. The foils 451 and 453 may be disposed along a same vertical axis as shown, or on different vertical axes on the support 341. Offsetting of foils along plural vertical axes, with respect to an upright wall or support in a liquid and solid fluid separation system, further extends laminar flow path and minimizes scour effect.

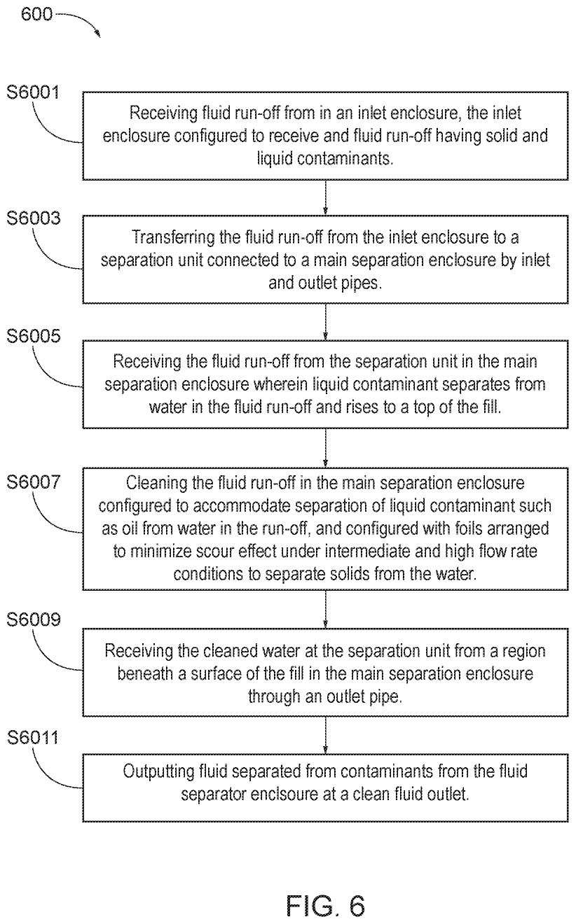

FIG. 6 shows methods useful for fluid run-off separation using a foil and system of the disclosure in accordance with an exemplary embodiment. In particular, FIG. 6 shows a method 600 including receiving at S6001 fluid run-off from in an inlet enclosure, the inlet enclosure configured to receive and fluid run-off having solid and liquid contaminants.

The fluid run-off contained in the inlet enclosure is transferred to a separation unit that connected to a main separation enclosure. The fluid run-off flows from the inlet enclosure to the separation unit at S6003 by a conduit or pipe such as an L-shaped pipe as shown in FIG. 2.

The fluid-run off flows from the separation unit to the main separation enclosure at S6005 through an inlet conduit or pipe connecting the separation unit to the interior of the main separation enclosure. The main separation enclosure is configured to facilitate separation of solid contaminants such as oil to separate from and rise to a surface of water in run-off. Additionally, the main separation enclosure is configured to facilitate precipitation of solid contaminants dissolved in the fluid run-off and minimizing resuspension of the precipitate under varying rates of fluid flow, including intermediate and high rates of fluid flow. For example, the main separation enclosure may be configured with one or more foils and and arranged as shown in FIGS. 1 and 3. Thus, the fluid run-off is cleaned at S6007 by effectively removing solid and liquid contaminants, leaving a region of clean water beneath a surface of the fluid fill in the main separation enclosure where an outlet pipe to the separation unit is located.

The cleaned fluid, for example, water is received at the separation unit from the main separation enclosure by the outlet pipe at S6009. The clean water is discharged through a system outlet at S6011.

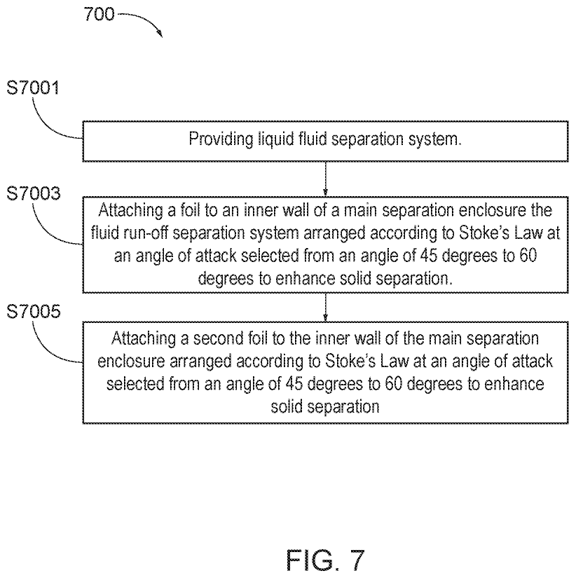

An existing liquid fluid separation system may be retro-fitted to include foils configured to minimize scour effect under varying flow rate conditions to facilitate both liquid fluid separation and solid fluid separation. For example, a liquid fluid separation system may be provided at S7001, as shown in FIG. 7. The liquid fluid separation system may be configured to separation liquid such as oil from water in fluid run-off using an inlet enclosure, a separation unit, and a main separation enclosure connected to the inlet enclosure by the separation unit, such as the systems disclosed by Pank, and made available through Baysaver Technologies. The interior of the main separation unit may be configured for effective solid removal from fluid run-off by incorporating one or more foils at S7003 as disclosed in FIGS. 1, 3, and 4-5. The foils may be arranged according to Stoke's Law, and each may be arranged at an angle of attack to fluid flow selected from a range of 45 degrees to 60 degrees, and preferably, 60 degrees. In an embodiment, a second foil may be attached to an interior of the main separation enclosure at S7005. The first foil incorporated at S7003 and the second foil incorporated at S7005 may be arranged to have different angles of attack with respect to a flow of fluid in the main separation enclosure. The first and second foils may be arranged along a same vertical axis, may be arranged on a same or different support, and may be arranged at a same or different height or distance from a bottom or top of a support or interior wall of the main separation enclosure.

Embodiments are shown by way of example, and not by way of limitation in the figures and drawings. While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A system useful for cleaning solid and liquid contaminants from fluid run-off, comprising:
an inlet enclosure;
a main separation enclosure comprising an intake, an outlet, and an interior wall; and
a foil attached to the interior wall of the main separation enclosure, the foil configured to smooth laminar flow of fluid in the main separation enclosure.

2. The system of claim 1, comprising one or more additional foil(s) connected to the interior wall.

3. The system of claim 1, comprising a separation unit connecting the inlet enclosure to the main separation enclosure.

4. The system of claim 1, the foil arranged at an angle of attack selected from a range of 45 degrees to 60 degrees to the fluid flow.

5. The system of claim 1, the foil arranged at an angle of attack of 60 degrees to the fluid flow.

6. The system of claim 1, the foil arranged at an angle of attack of 45 degrees or greater.

7. The system of claim 1, the foil connected to the interior wall by a support.

8. The system of claim 1, the foil connected directly to the interior wall.

9. The system of claim 1, foil configured to extend toward a center of main separation enclosure.

10. The system of claim 1, the foil having a substantially planar surface.

11. The system of claim 1, comprising a second foil.

12. The system of claim 11, the second foil connected to the interior wall.

13. The system of claim 12, the first foil arranged at a first angle of attack to the fluid flow in the enclosure, the second foil arranged at a second angle of attack to the fluid flow in the enclosure.

14. The system of claim 13, the first angle attack equal to the second angle of attack, or greater than the second angle of attack.

15. The system of claim 11, the first foil arranged at a distance from a bottom of the enclosure that is different than a distance from the bottom of the main separation enclosure of the second foil.

16. A method useful for separating solid and liquid contaminants from fluid run-off, comprising:
receiving fluid run-off from in an inlet enclosure, the inlet enclosure configured to receive and fluid run-off having solid and liquid contaminants;
transferring the fluid run-off from the inlet enclosure to a separation unit connected to a main separation enclosure by inlet and outlet pipes;
receiving the fluid run-off from the separation unit in the main separation enclosure wherein liquid contaminant separates from water in the fluid run-off and rises to a top of the fill;
cleaning the fluid run-off in the main separation enclosure configured to accommodate separation of liquid contaminant such as oil from water in the run-off, and configured with foils arranged to minimize scour effect under intermediate and high flow rate conditions to separate solids from the water;
receiving the cleaned water at the separation unit from a region beneath a surface of the fill in the main separation enclosure through an outlet pipe; and
outputting fluid separated from contaminants from the fluid separator enclsoure at a clean fluid outlet.

17. The method of claim 16, the angle of attack selected from a range of 45 degrees to 60 degrees.

18. The method of claim 16, the angle of attack being about 60 degrees.

19. The method of claim 18, the main separation enclosure comprising a second foil configured to smooth laminar flow.

20. A method useful for forming a system for separating solid and liquid contaminants from fluid run-off fluid, comprising:
providing liquid fluid separation system;
attaching a foil to an inner wall of a main separation enclosure the fluid run-off separation system arranged according to Stoke's Law at an angle of attack selected from an angle of 45 degrees to 60 degrees to enhance solid separation; and
attaching a second foil to the inner wall of the main separation enclosure arranged according to Stoke's Law at an angle of attack selected from an angle of 45 degrees to 60 degrees to enhance solid separation.
